(19) United States
(12) Patent Application Publication
(10) Pub. No.: US 2017/0358841 A1
(43) Pub. Date: Dec. 14, 2017

(54) MULTI-LAYER MICRO RECEIVER FOR A WIRELESS COMMUNICATION SYSTEM

(71) Applicant: MEDELLA HEALTH INC, Kitchener (CA)

(72) Inventor: Luyao Chen, Kitchener (CA)

(73) Assignee: MEDELLA HEALTH INC., Kitchener (CA)

(21) Appl. No.: 15/521,083

(22) PCT Filed: Oct. 20, 2015
(86) PCT No.: PCT/CA2015/051055

§ 371 Date: Apr. 21, 2017

Related U.S. Application Data
(60) Provisional application No. 62/066,805, filed on Oct. 21, 2014.

(51) Int. Cl. H01Q 1/24; H01Q 1/38; H01Q 1/42; H01Q 1/22

(52) U.S. Cl. CPC H01Q 1/241; H01Q 1/422; H01Q 1/38; H01Q 1/2208

(57) ABSTRACT

Various embodiments are described herein for a micro-antenna comprising a first substrate layer having a first antenna winding trace thereon: a second substrate layer having a second antenna winding trace thereon; and at least two couplers to couple the first and second antenna winding traces. Various embodiments are also described for a multilayer receiver that incorporates any of the micro-antenna embodiments described herein and microcircuitry.

### CROSS-REFERENCE TO RELATED APPLICATION

This application claims priority from U.S. provisional patent application No. 62/066,805, filed Oct. 21, 2014 entitled “MULTI-LAYER MICRO RECEIVER FOR A WIRELESS COMMUNICATION SYSTEM”, the disclosure of which is incorporated herein, in its entirety, by reference.

### FIELD

The various embodiments described herein generally relate to wireless communication systems that have multi-layer micro receivers.

### BACKGROUND

A very fast growing trend in mobile technology is the use of flexible antennas in wireless micro-machineries. Part of this growth is due to the development of wearable lifestyle monitoring devices to promote efficiency in the health and fitness space. Advancement of microelectronics and wireless communication has also enabled technology to be integrated onto human bodies with the highest degree of subtlety. However, the implementation of these devices on the human body varies greatly depending on the application, which ranges from being temporarily wearable as clothing accessories to prolonged wearing periods as in medical implants. These different applications generally require modifications to be made to the receiving device including the antenna. This is especially true since the human body is a very complex environment in the perspective of electromagnetic propagation, which is used to transmit information between wireless devices. Interestingly, most wearables are considered “near-body”, rather than “on-body”, where the antenna is within a fraction of a millimeter from an organic tissue.

### SUMMARY OF VARIOUS EMBODIMENTS

Various embodiments for a wireless communication system having a multi-layer micro receiver are provided according to the teachings herein. The wireless communication system may be used for various types of RF wireless usage, including RFID, on various surfaces such as, but not limited to, a biological surface such as on or in a body of an individual or an animal. The various embodiments of a multilayer receiver described herein for “on-body” usage provides a significant addition to the limited solutions that are available for the RFID standard.

In general, the wireless communication system comprises a micro receiver, a reader device and communication therebetween. The micro receiver is generally distributed over several layers on a substrate, which may be flexible. The micro receiver generally includes a multilayer antenna. In at least some embodiments, the reader may be a hand-held device.

By using a multilayer micro-receiver, the communication system may be used for various types of surfaces including complex surfaces with possibly complex electrical properties such as, but not limited to, an eyeball, skin tissue, natural/polymer fabric, fur, wood/bark, glass, for example.

In a broad aspect, at least one embodiment described herein provides a micro-antenna comprising a first substrate layer having a first antenna winding trace thereon; a second substrate layer having a second antenna winding trace thereon; and at least two couplers to couple the first and second antenna winding traces.

In at least some embodiments, the micro-antenna may further comprise a passivation layer that covers the antenna winding trace on a topmost substrate layer.

In at least some embodiments, at least one of the substrate layers and the passivation layer may comprise water impermeable material.

In such embodiments, the water impermeable material may comprise at least one of polyimide, polyurethane, and parylene.

In at least some embodiments, the antenna winding traces from different substrate layers may at least partially overlap with one another.

In at least some embodiments, the antenna winding trace on a given substrate layer is at least partially concentric.

In at least some embodiments, the antenna winding trace on a given substrate layer may comprises at least two loops that do not intersect.

In at least some embodiments, the micro-antenna may further comprise micro-vias for coupling the antenna winding traces on different substrate layers.

In at least some embodiments, the antenna winding traces may generally have a circular shape.

In at least some embodiments, the substrate layers may have a circular shape and the winding traces are disposed along an outer ring of the substrate layers.

In at least some embodiments, the antenna winding traces may comprise metal having at least one of copper, gold, silver and conductive ink.

In at least some embodiments, the substrate layers of the micro-antenna may be shaped to be received on a contact lens and the substrate layers are made from a biocompatible polymer.

In such embodiments, the biocompatible polymer may comprise one or more biocompatible polymeric materials including polyimide, hydrogel, polyethylene terephthalate (PET), parylene, polyethylene naphthalate, polypropylene, polyimide, polyimide, and thermoplastics.

In at least some embodiments, the antenna winding traces may have one of a square, rectangular, triangular, star and elliptical shape.

In at least some embodiments, the micro-antenna may further comprise at least one additional substrate layer having antenna winding traces thereon that are coupled to at least one of the antenna winding traces on the first and second substrate layers.

In another broad aspect, at least one embodiment described herein provides a receiver for a communication system, wherein the receiver comprises a multilayer antenna that is defined in accordance with the teachings herein; and microcircuitry disposed on at least one of the substrate layers and coupled to a first and second portion of the multilayer antenna.

In at least some embodiments, the receiver may further comprise a passivation layer covering the microcircuitry on a topmost substrate layer.

In at least some embodiments, the substrate layers may have a circular shape, the winding traces are disposed along an outer ring of the substrate layers and the microcircuitry is disposed along a portion of the outer ring.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described.

FIG. 1 is an exploded perspective view of an example embodiment of a multilayer receiver having a multilayer antenna.

FIG. 2 is a cross-sectional view of the multilayer receiver of FIG. 1.

FIGS. 3A-3C show top views of each layer of the multilayer receiver of FIG. 1.

FIG. 4 shows inductance calculations for antenna windings distributed over two layers.

FIGS. 5A-5B show top views of each layer of an example embodiment of a two layer receiver.

FIG, 6 shows a top view of an example embodiment of a multilayer antenna where one of the layers includes a tuning stub.

FIG. 7A shows a top view of an example of an upper layer of a multilayer receiver in which antenna winding traces are coupled to a microchip.

FIG. 7B shows a cross-sectional view of an example embodiment of internal connections between antenna winding traces and a microchip.

FIG. 7C shows a cross-sectional view of another example embodiment of internal connections between antenna winding traces and a microchip.

FIG. 7D shows a cross-sectional view of another example embodiment of internal connections between antenna winding traces and a microchip.

FIG. 7E shows a top view of an example embodiment of a coupling between an antenna winding trace and an IC on a top substrate layer.

FIG. 7F shows a top view of an example embodiment of a coupling between a sensor, an IC and an antenna winding trace on a top substrate layer.

FIG. 8 shows a block diagram of an example embodiment of a communication system that uses a multilayer micro-receiver.

FIG. 9 shows a flow chart of an example embodiment of a method of operation for a communication system having a multilayer micro-receiver.

Further aspects and features of the embodiments described herein will appear from the following description taken together with the accompanying drawings.

### DETAILED DESCRIPTION OF THE EMBODIMENTS

Various apparatuses or processes will be described below to provide an example of at least one embodiment of the claimed subject matter. No embodiment described below limits any claimed subject matter and any claimed subject matter may cover processes, apparatuses or systems that differ from those described below. The claimed subject matter is not limited to apparatuses, processes or systems having all of the features of any one apparatus, process or system described below or to features common to multiple or all of the apparatuses, or processes or systems described below. It is possible that an apparatus, process or system described below is not an embodiment of any claimed subject matter. Any subject matter that is disclosed in an apparatus, process or system described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical element or electrical signal (either wired or wireless) or a mechanical element depending on the particular context.

It should be noted that terms of degree such as “substantially”, “about” and “approximately” as used herein mean a reasonable amount of deviation of the modified term such that the end result is not significantly changed. These terms of degree may be construed as including a certain deviation of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made if the end result is not significantly changed.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Described herein are various example embodiments for a multilayer micro receiver and an associated communication system that may be used for communication over complex surfaces with potentially complex electrical properties such as, but not limited to, biological layers. The micro receiver is generally distributed over several layers of substrates and generally includes a multilayer antenna. The general design of approach for the multilayer micro receiver in accordance with the teachings herein generally enhances efficiency, provides space for peripheral microcircuitry and makes use of materials that are flexible and biocompatible and some of which are protective.

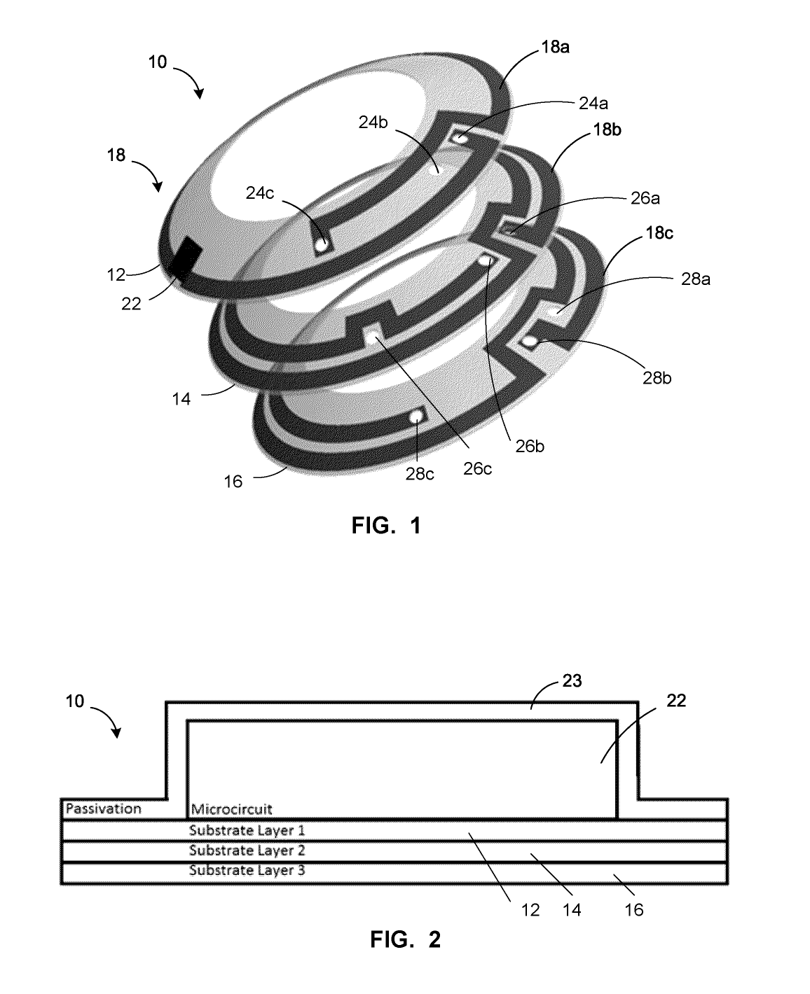

Referring now to FIG. 1, shown therein is an exploded perspective view of an example embodiment of a multilayer receiver 10 having a multilayer antenna 18. In this example, there are three substrate layers 12, 14 and 16 each having an antenna winding trace 18a, 18b and 18c respectively. Each antenna winding trace 18a, 18b and 18c has a certain pattern generally have a circular shape. It should be noted that in alternative embodiments, there may be a different number of substrate layers and/or different patterns that are used for each antenna winding trace 18a, 18b and 18c. Some other variations are also described in further detail below.

The receiver 10 includes microcircuitry 22 which may be located on the first substrate layer 12 and may be coupled to the antenna winding trace 18a on the first substrate layer 12. The microcircuitry 22 may comprise one or more of at least one IC, at least one sensor and at least one chip-less system. An example of a chip-less system is a receiver comprising an antenna with just a sensor that changes the antenna's impedance depending on what is being sensed. A reader picks up on this change in impedance, which may indicate a reaction from the sensor to an external excitation. The receiver 10 is a wirelessly powered wireless communication platform where it may both supply power and exchange information with an external reader by using peripheral hardware—e.g. the microcircuitry 22.

In alternative embodiments, the microcircuitry 22 may be on a different substrate layer or it may be distributed over several substrate layers. For example, the microcircuitry 22 may be on a 10 μm flexible sheet instead of 70 μm rigid die. In this case, there may be situation where the surface area of a single substrate layer is not enough to support all of the microcircuitry 22. However, this can be addressed by separating the components of the microcircuitry 22 on different layers. In some embodiments, the flexible microchip 22 can also be sandwiched between substrate layers instead of occupying the top layer.

To achieve the coupling of antenna winding traces or different components of the microcircuitry 22 that are on different substrate layers, there may be more micro-vias for coupling different micro-circuits, or sections of a single micro-circuit. If the micro-circuit is built using flexible CMOS, which has a thickness of 20 um, then the entire circuitry can be hidden between substrates. There will no longer be a need for passivation. For regular silicon CMOS, it can be flipped over with its bottom facing upwards so that its electrically sensitive parts are being protected by the substrate. The windings will have to go around the buried IC.

Each substrate layer 12, 14 and 16 for the receiver 10 also has couplers that are used to couple the antenna windings and other structures that are distributed on different substrate layers together. In this example embodiment, the couplers are micro-vias. There may be different kinds of vias that may be used such as, but not limited to, through-hole, blind vias, and buried vias. In this example embodiment, the substrate layer 12 comprises micro-vias 24a, 24b and 24c, the substrate layer 14 comprises micro-vias 26a, 26b and 26c and the substrate layer 16 comprises micro-vias 28a, 28b and 28c.

In this example embodiment, the micro-vias 24a and 26a couple a first end of the antenna winding trace 18a to a first end of the antenna winding trace 18b while the micro-via 28a does not provide any coupling to the antenna winding trace 18c on the substrate layer 16. Furthermore, the micro-vias 26b and 28b couple a second end of the antenna winding trace 18b to a first end of the antenna winding trace 18c while the micro-via 24b does not provide any coupling to the antenna winding trace 18a on the substrate layer 12. In addition, the micro-vias 28c and 24c couple a second end of the antenna winding trace 18c to a second end of the antenna winding trace 18a thereby completing the antenna loop. Accordingly, a micro-via is coupled to an antenna winding trace when it makes contact with that trace and a via is not coupled to an antenna winding trace when it does not contact the antenna winding trace.

In this example embodiment, during use, any induced current in the multilayer antenna 18 travels a circular section on the substrate layer 12 about 1.25 times, then travels a circular section on the substrate layer 14 about two times and then travels a circular section on substrate 16 about 2 times before being coupled back to the antenna winding trace 18a on the substrate layer 12.

In this example embodiment, while one side of the microcircuitry 22 was coupled to one end of an antenna winding trace on the topmost substrate layer 12 and another side of the microcircuitry 22 was coupled to an end of an antenna winding trace on the lowest substrate layer 16, this does not always have to be done. However, this configuration does provide the widest opening (i.e. space not covered by any traces or circuitry) at the center of the substrate layers for a constant set of winding dimensions.

Since the process of creating micro-vias requires creating holes through all of the substrate layers, there may be some micro-vias on some of the substrate layers where an antenna winding trace passes over them. Alternatively, some antenna winding traces must go around the micro-vias where there is to be no electrical connection. Therefore, when more micro-vias are made to connect the antenna winding traces over more substrate layers, the loops of the antenna winding traces occupy additional area on each substrate layer.

The microcircuitry 22 may be coupled between first and second portions of the antenna winding trace 18a. In general, the top substrate layer 12 may have the most open space for peripheral hardware—e.g. the microcircuitry 22. The microcircuitry 22 may be located on the peripheral of the substrate layer 18a to have minimal optical interference with any light that passes through the center of the multilayer antenna 18. This is beneficial for certain applications. This configuration also incorporates the convenience of leading the ends of the antenna winding traces to terminals of the microcircuitry without the need for “bridging”.

The microcircuitry 22 may include various types of electronic devices such as, but not limited to, at least one microprocessor, filter, amplifier and/or a sensor, for example. However, the microcircuitry 22 is not technically part of the multilayer antenna 18, and it is shown in the figures to clarify the location of where the multilayer antenna 18 and any circuitry of the receiver 10 may be coupled to one another. The microcircuitry 22 may be made of highly conductive material.

In alternative embodiments, the top substrate layer may have more loops of antenna winding traces while one of the intermediate substrate layers or the bottom substrate layer may have fewer loops of antenna winding traces as well as a portion or all of the microcircuitry 22.

In cases, where there microcircuitry 22 comprises given components that need exposure to certain substances or surfaces, such as sensors, for example, those given components or the whole microcircuitry 22 may be disposed on the top layer of the multilayer receiver. When this is not the case, then the microcircuitry 22 may be disposed on one or more of the intermediate substrate layers and/or the bottom substrate layer.

The antenna winding traces 18a, 18b and 18c as well as the microcircuitry 22 may be made using ultra-thin metallic structures and/or highly conductive material. The highly conductive material that may be used includes, but is not limited to, copper, gold and silver. Conductive ink traces such as silver ink may also be used for the metallic traces. However, copper may be preferred as it may be used to maximize conductivity for the circuit elements. Furthermore, a highly conductive material is preferable for the antenna winding traces due to performance issues.

The conductors that are used for the antenna winding traces 18a, 18b and 18c may be between about 5 μm to about 15 μm depending on the operating frequency and the values selected for the other design parameters of the multilayer antenna 18. When the wavelength for wireless communication is shorter than the transmitting distance, the antenna winding traces become sensitive to its thickness (i.e. not its width).

As can be seen, the multilayer structure allows a larger antenna to be implemented without obstructing any additional surface area of any of the underlying substrates. For instance if the antenna is a loop antenna, the antenna winding traces may be distributed along an outer ring of each of the substrate layers. This geometric layout for the antenna winding traces may provide several advantages such as:
1) allowing for use in some applications where certain areas of the substrate should not be blocked, such as when the multilayer receiver and antenna structure is mounted on the surface of a contact lens in which case the unblocked areas are important as they allow the sight of the contact lens wearer to be unobstructed;
2) allowing for an increase in both the number of antenna windings and the individual width of the antenna windings, while retaining an unobstructed window for the body surface;
3) allowing for the use of the most outer ring near the perimeter of the contact lens due to having less features per layer (i.e., less antenna winding loops per substrate layer means the antenna winding loops can have a larger radius on average since 6 antenna winding loops on one layer have 6 decreasingly different radii as the antenna winding loops approaches the center of the substrate layer while 6 antenna winding loops on three different substrate layers have 2 different radii); and
4) allowing for more magnetic flux to be captured by the antenna due to the larger inner diameter of the windings and therefore being able to generate a higher amplitude current due to induction.

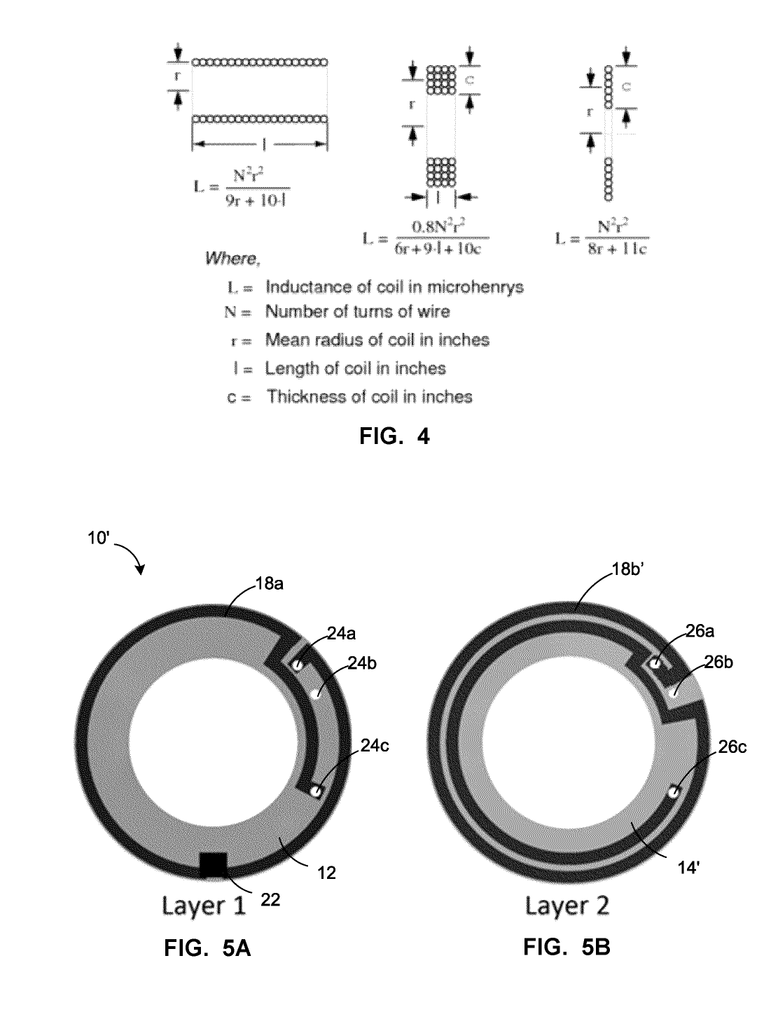

On a given substrate layer, there may an antenna winding trace that has more than two loops but more loops of antenna winding traces on a given substrate layer may come at the expense of either a smaller opening in the middle of the antenna winding traces, or the use of thinner traces. In fact, having more substrate layers results in the use of more loops of antenna winding traces per layer. Since the process of creating through-hole vias requires a hole through all substrate layers, there will be vias where an antenna winding trace passes over the via but some antenna winding traces must go around the vias. Therefore, when more vias are made to couple traces on more substrate layers, the antenna winding loops must occupy additional area on each layer to pass around some of the vias. For example, in FIG. 3C, there is a protrusion from the 2^{nd} antenna loop winding to a partial 3^{rd} antenna loop winding at the 1 o'clock to 2 o'clock position to avoid contact with the via. However, this may not be the case blind and buried vias on flexible multilayer structures may be used.

In some embodiments, the antenna winding traces for each loop on the same substrate layer may have the same width. However, in alternative embodiments, the antenna winding traces for each loop on the same substrate may have different widths which may be used when needed to satisfy the performance specifications. If antenna winding traces for each loop on the same substrate have different widths, the result is a shift in the operating frequency of the multi-layer antenna and perhaps its efficiency.

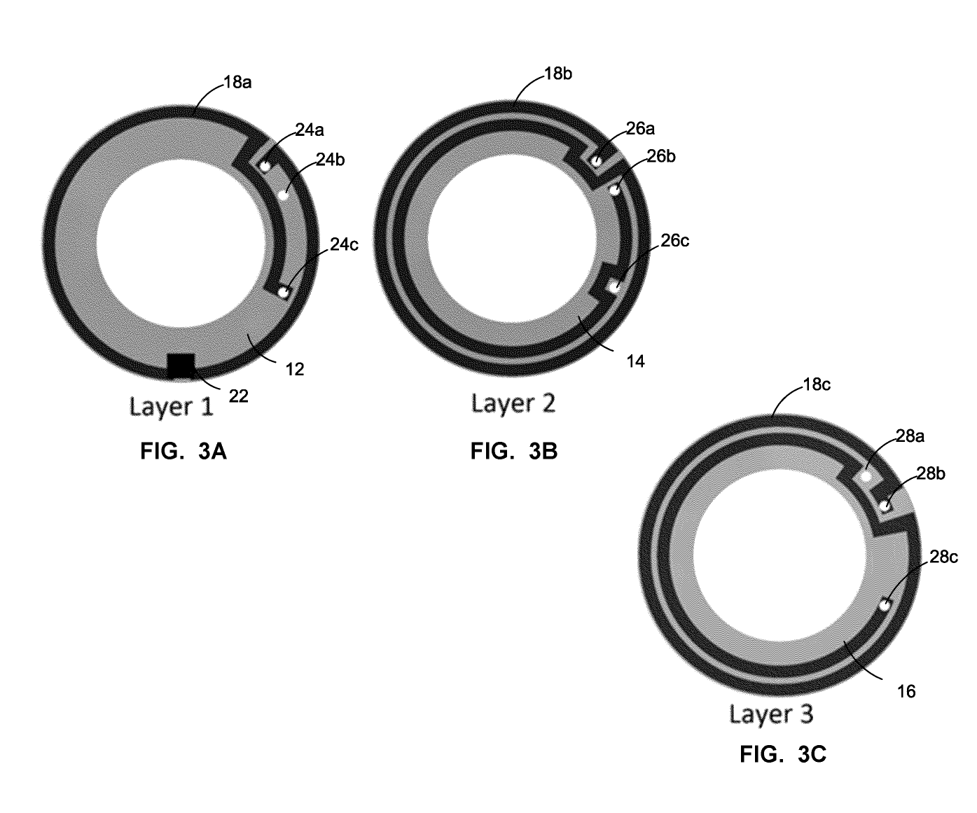

Referring now to FIGS. 2 and 3A to 3C, shown therein is a cross-sectional view of the multilayer receiver 10 of FIG. 1 and top views of each substrate layer of the multilayer receiver 10 along with associated antenna winding traces and micro-vias, respectively. FIG. 3A shows layer 1 which is the top layer, FIG. 3B shows layer 2 which is the middle layer and FIG. 3C shows layer 3 which is the bottom layer for this example embodiment.

In FIG. 2, the substrate layers 12, 14 and 16 are shown stacked on one another but it should be understood that there are antenna trace windings between each of these substrate layers. The microcircuitry 22 is shown disposed on the top substrate layer 12. However, in alternative embodiments the microcircuitry 22 may be disposed on one or more of the other substrate layers. In addition, the multilayer antenna 18 and the multilayer receiver 10 for that matter may include a passivation layer 23 that is the topmost layer and provides protection against any impurities, although the passivation layer 23 may be optional in certain circumstances.

The substrate layers 12, 14 and 16 and the passivation layer 23 may also be water impermeable in order to protect the microcircuitry 22 and the multilayer antenna 18. In particular, the passivation layer 23 may shield antenna winding traces, microcircuitry and any other metal traces from potentially corrosive or electrically conductive substances such as tear fluid when the receiver 10 is used with a contact lens. Although the multilayer antenna 18 will still function, its performance will be more consistent and longer-lasting when protection is provided by a water impermeable material such as, but not limited to, polyimide, polyurethane, or parylene, for example. Polyimide and parylene have a very small effect on the performance of both active and passive electrical components. Their electric properties are negligible when the micro-receiver 10 is placed close to a human or animal body or biological surface. Parylene may be applied like a coating and cured to harden (while still being flexible).

The substrate layers 12, 14 and 16 and the passivation layer 23 may also be biocompatible so that the multilayer receiver 10 may be used on biological surfaces. Accordingly, the substrate layers 12, 14 and 16 as well as the passivation layer 23 may generally be made using one or more polymeric materials that are biocompatible such as, but not limited to, polyimide, hydrogel, polyethylene terephthalate (PET), polyurethane, parylene, polyethylene naphthalate, polypropylene, polyimide, polyamide, and thermoplastics, for example.

It should be noted that the passivation layer 23 may be optional in that it may not be needed for the antenna portion of the multilayer receiver 10, but it is recommended for use with the microcircuitry 22. Whether the environment is wet or dry, as long as the metal isn't being corroded, then the antenna will function regardless.

The substrate layers 12, 14 and 16 and the passivation layer 23 may also act as dielectrics to help increase the magnetic inductance of the multilayer antenna 18. The dielectric values of these dielectric layers may have an effect on the operation of the multilayer antenna 18, but the effect should be minor and may be mitigated by choices made for other areas of the design such as the capacitance values of any capacitors that are used as part of the microcircuitry 22.

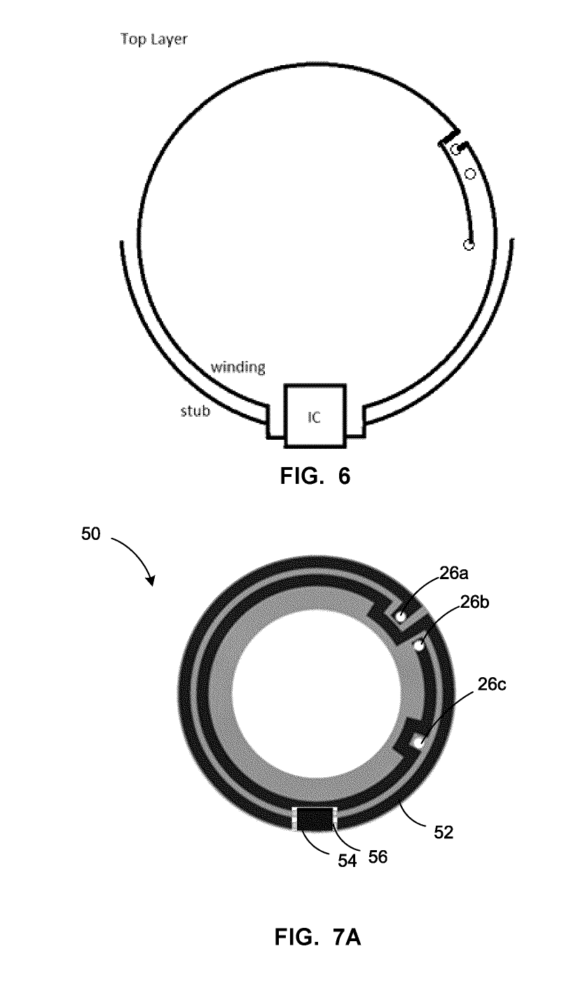

Since the size of the multilayer antenna 18 is small, the goal of the design is to reduce any losses as much as possible. One such way may be to make the antenna winding traces 18a, 18b and 18c have larger trace widths and larger trace diameters and to make the gap (i.e. the thickness of the substrate layers 12, 14 and 16) between the antenna winding traces 18a, 18b and 18 large. By expanding the antenna winding traces onto multiple layers, the method of calculation for inductance changes from that of a single layer antenna. Therefore, the loss factor is contributed by the thickness of the substrates as is shown in FIG. 4, rather than the width of antenna winding traces as is the case for a single layer inductor. FIG. 4 shows inductance calculations for antenna windings distributed over two layers. In particular, FIG. 4 shows the cross-sectional side view of 3 different forms of inductors. The hollow dots are the cross-section of the traces. The multilayer in this claim follows the middle structure, and the structure on the right is multiple loops on a single layer.

In general, the thickness for a typical substrate layer (i.e. dielectric layer) depends on the application of the multilayer receiver 10. For example, for contact lens applications in which the multilayer receiver 10 is mounted on a contact lens, a typical substrate layer may have a thickness of about 5 μm to 10 μm. However, in other applications such as stick-on patches for the body of an individual or animal, the substrate layer may be as thick as 50 μm.

It should be noted that in some embodiments, the multilayer antenna may comprise more than three substrate layers that each have antenna winding traces. Alternatively, in some embodiments, the multilayer antenna may comprise two substrate layers that each has antenna winding traces.

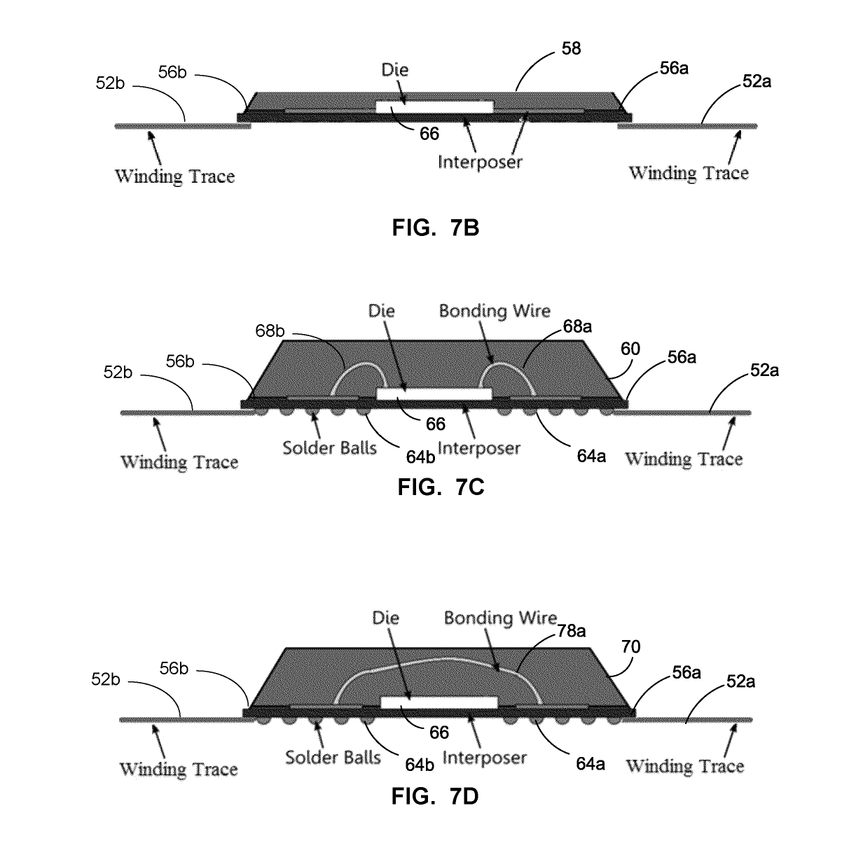

For example, referring now to FIGS. 5A and 5B, shown therein are top views of each layer of an example embodiment of a two layer receiver 10′ having a first substrate layer 12 and a second substrate layer 14′ that are very similar to the first and second substrate layers 12 and 14 of the multilayer receiver 10. However, antenna winding trace 18b′ on the second substrate layer 14′ is different than the antenna winding trace 18b on the second substrate layer 14 of the multilayer receiver 10.

In this example embodiment, the micro-vias 24a and 26a couple a first end of the antenna winding trace 18a to a first end of the antenna winding trace 18b′. Furthermore, the micro-vias 24c and 26c couple a second end of the antenna winding trace 18a to a second end of the antenna winding trace 18b′. The micro-vias 24b and 26b do not provide any coupling and can be omitted.

In this example embodiment, during use, any induced current in the multilayer antenna 18 travels a circular section on the substrate layer 12 about 1.25 times and travels a circular section on the substrate layer 14′ almost two times.

In alternative embodiments of multilayer antennas that have 4 substrate layers, if the width of the antenna winding traces and the gap between the antenna winding traces are kept to a constant, then the four layer structure would require 4 micro-vias, and antenna winding traces with 4 different radii from the center on each substrate layer. There will be 3 complete loops on all substrate layers except for the top substrate layer, which may only have 1 complete loop to provide more space on the top substrate layer for one or more sensor(s) and other peripheral microcircuitry. Each set of vias may be arranged to be on a single row in the azimuth plane, and the gap distance between micro-vias are the width of the antenna winding traces plus some margin. The antenna winding will use the gap between micro-vias to traverse between different radii of the winding sequence. All antenna winding traces are still able to travel in either a clockwise or a counter clockwise direction. In addition, the coupling between the multilayer antenna and the microcircuitry IC will still be the same as that shown for the example two layer and three layer antennas.

Referring now to FIG. 6, shown therein is a top view of an example embodiment of a multilayer antenna where one of the layers includes a tuning stub. In this example embodiment, the antenna winding trace appears to be a full winding, but there may be micro-vias on either side of the IC at the portion of the traces between the IC and the junction of the antenna winding trace and the tuning stub and these micro-vias may be coupled to antenna winding traces on a different substrate layer.

The tuning stub may be used for impedance matching and may be configured as a short circuit stub or an open circuit stub depending on the length of the stub in terms of the wavelength of operation for the multilayer antenna 18. The tuning stubs may be on any substrate layer and coupled to the antenna winding traces at any point as long as they do not short the antenna windings traces. In some embodiments, the tuning stubs may be asymmetrical. Additionally, or in the alternative, there may be more or less than 2 tuning stubs of any length. The tuning stubs may be useful when there is a need to change the impedance (permanently) without modifying the structure of the antenna winding traces or its size.

Since the multilayer structure of the receiver 10 is flexible, it can be made into any geometric shape before integrating it onto a complex surface. For example, the multilayer structure of the receiver 10 may have a spherical shape for use on rounded objects such as the human skull, for example. In alternative embodiments, the multilayer structure of the receiver 10 may be cylindrical in shape for use on objects such as a human or animal arm. In still further alternative embodiments, the multilayer structure of the receiver 10 may be triangular in shape and may be applied to various biological surfaces such as, but not limited to, the human nose ridge flat. In still further alternative embodiments, the multilayer structure of the receiver 10 may have a wavy shape so that it may be used in human skin folds, for example.

In alternative embodiments, other shapes may be used for the antenna winding traces rather than having them be generally circular in shape. For example, the antenna winding traces can be patterned in any shape as long as these traces spin in the same direction and connect to the chip terminal(s). Some example shapes for the antenna winding traces may include, but are not limited to, square, rectangular, triangle, star and elliptical, for example. While the antenna winding traces are looped and have a circular shape, the principle of the subject matter described in accordance with the teachings herein is applicable to any loop type at any frequency.

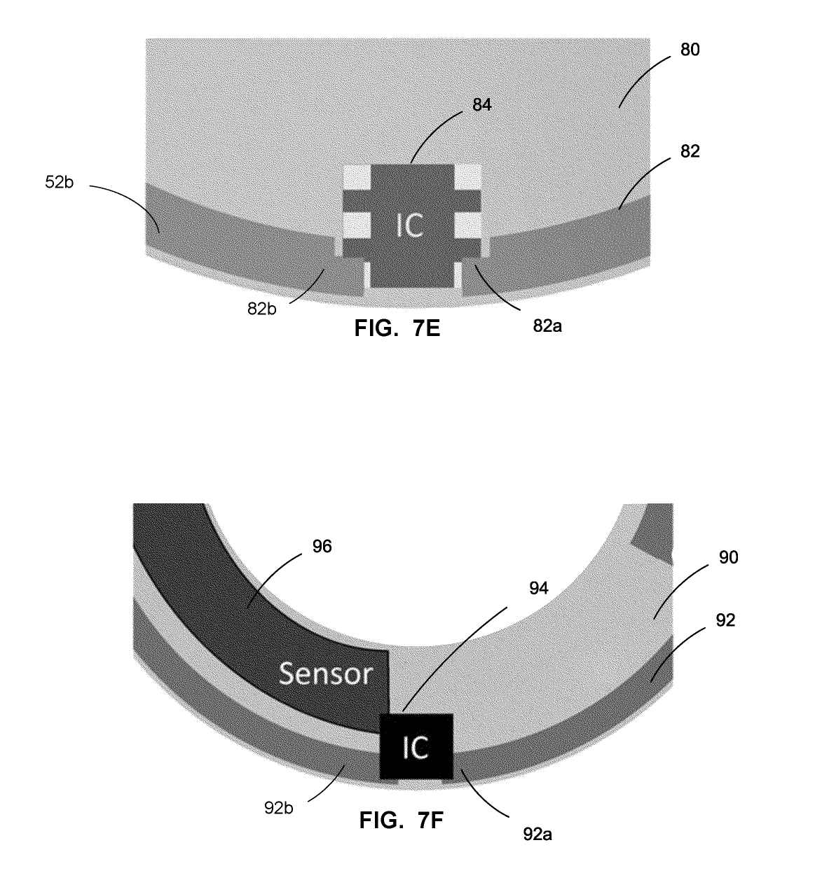

Referring now to FIG. 7A, shown therein is a top view of an example of an upper layer 50 of a multilayer receiver in which antenna winding traces 52 are coupled to a microchip 54 that serves as part of the microcircuitry 22. The housing for the microchip 54 comprises several contacts 56 on each side of the housing. The antenna winding traces 52 generally couple with some of the contacts 56 on both sides of the housing of the microchip 54. As can be seen the microchip 54 is peripherally disposed with respect to the antenna winding traces 52.

Referring now to FIG. 7B, shown therein is a cross-sectional view of an example embodiment of internal connections between antenna winding traces 52a and 52b and contacts 56a and 56b of a microchip 58. An interposer is an electrical interface routing between one socket or connection to another and many such interface routings are possible. Some examples of such connections are shown in FIGS. 7C and 7D. The coupling shown in FIG. 7B is compatible with the multilayer receiver.

Referring now to FIG. 7C, shown therein is a cross-sectional view of an example embodiment of internal connections between antenna winding traces 52a and 52b and contacts 56a and 56b of a microchip 60. The coupling shown in FIG. 7C is compatible with the multilayer receiver. In this example, the antenna winding traces are broken on the substrate layer and a microchip is fitted to where the antenna winding traces are broken. The broken antenna winding traces are then continued on specially-made routing traces within the die of the microchip.

The microchip 60 includes solder balls 64a which facilitate an electrical bond generally between the contacts 56 and portions of the antenna winding traces 52. In this example embodiment, the contacts 56a and 56b are shown electrically coupled to the antenna winding traces 52a and 52b, respectively. The contacts 56a and 56b are then coupled to the interposer 66 via bonding wires 68a and 68b. In this example, a portion of the antenna windings are routed along the interposer 66 for connection or coupling with one another. Accordingly, the solder balls 64a and bonding wires 68a and 68 become interconnects between the antenna winding traces 52 on the substrate layer and the routing traces on the die of the microchip 60.

Referring now to FIG. 7D, shown therein is a cross-sectional view of another example embodiment of internal connections between antenna winding traces 52a and 52b and contacts 56a and 56b of the microchip 70. The coupling shown in FIG. 7D is compatible with the multilayer receiver. Again, the microchip 70 solder balls 64a facilitate an electrical bond generally between the contacts 56 and portions of the antenna winding traces 52.

In this example embodiment, the contacts 56a and 56b are shown electrically coupled to the antenna winding traces 52a and 52b, respectively. The contacts 56a and 56b are also coupled to each other via a bonding wire 78a. In addition, a portion of the antenna windings pass over the interposer 66 and are directly coupled with one another. With the coupling shown in FIGS. 7B, 7C and 7D, one can have more antenna winding traces on the layer where the IC is placed.

A technical advantage of combining either of these bonding methods with a multilayer receiver is that each substrate layer of the multilayer receiver may be able to support more antenna winding traces.

Referring now to FIG. 7E, shown therein is a top view of an example embodiment of a coupling between first and second portions 82a and 82b of an antenna winding trace 82 and an IC 84 on a top substrate layer 80. In this example, the microcircuitry is the IC 84 and the squares protruding from the sides of the IC 84 are conductive contact pads. The antenna winding terminals 82b and 82a couple directly to the contact pads using either solder or conductive adhesives.

Referring now to FIG. 7F, shown therein is a top view of an example embodiment of a coupling between a sensor 96, an IC 94 and two portions 92a and 92b of an antenna winding trace 92 on a top substrate layer 90. In this example, the sensor 96 may be one or more electrodes and each of the electrodes may be coupled to contact pads (not shown) of the IC 94 using a conductive adhesive, for example. The electrodes cannot touch one another, and there may be 1 to 4 electrodes depending on the specific sensor. The sensor electrodes do not have to have the same shape and size. Depending on the application, the sensor may be exposed to body fluids, or it may be encapsulated between water impermeable coatings. For example, a glucose sensor on a contact lens is implemented such that it may make contact with the user's tears, but if the sensor were a temperature sensor then the environment around the sensor may be an encapsulated dry environment.

An example of a multilayer antenna design now follows for operation at a frequency ranges of 100 KHz to 50 MHz and 1.5 GHz to 2.5 GHz. The example multilayer antenna includes antenna winding traces that are about 400 μm in width and a gap of 200 μm between antenna winding traces on adjacent substrate layers. The radius of the outer winding of the antenna winding trace from the center of antenna winding traces is about 5 mm. The conductor thickness is about 4 μm. The total number of substrate layers is 3 and the total number of antenna winding traces is 5 (which is similar to what is shown in FIGS. 1 and 3A to 3C.

In order to operate in the range of 100 KHz to 50 MHz or the range of 1.5 GHz to 2.5 GHz, changes may be made inside the microcircuitry IC to provide matching for the antenna. The antenna structure itself will not have to be changed at all. It has a self-resonance at around 2 GHz to 2. 5 GHz, which makes it a natural radiator at that frequency. The helical shape of the antenna also ensures that there is enough inductance so that the micro receiver to function as an inductive coupler at low frequencies from 10 MHz to 50 MHz. In other words, it's an antenna at GHz frequency, and an inductor at MHz frequency.

In general, with the teachings herein, the multilayer antenna may generally be used in a frequency range of 10 MHz to 6 GHz. However, theoretically the multilayer antenna may be operated at any frequency. The following parameters can be changed adjusting to a frequency while keeping to an overall similar design:

1: Number of loops of antenna winding traces per layer;

2: Number of substrate layers;

3: Width of the antenna winding traces;

4. The vertical gap distance between traces;

5. Dielectric thickness;

6. Different dielectric material;

7: Different passivation layer;

8: Different conductors; and

9: Adding tuning stubs to the antenna depending on the frequency.

In order to design the multilayer antennas in accordance with the teachings described herein, a software modelling program may be used. For example, the software that may be used includes Advanced Design Systems (ADS) from Keysight and High Frequency and Structural Simulator (HFSS) from ANSYS.

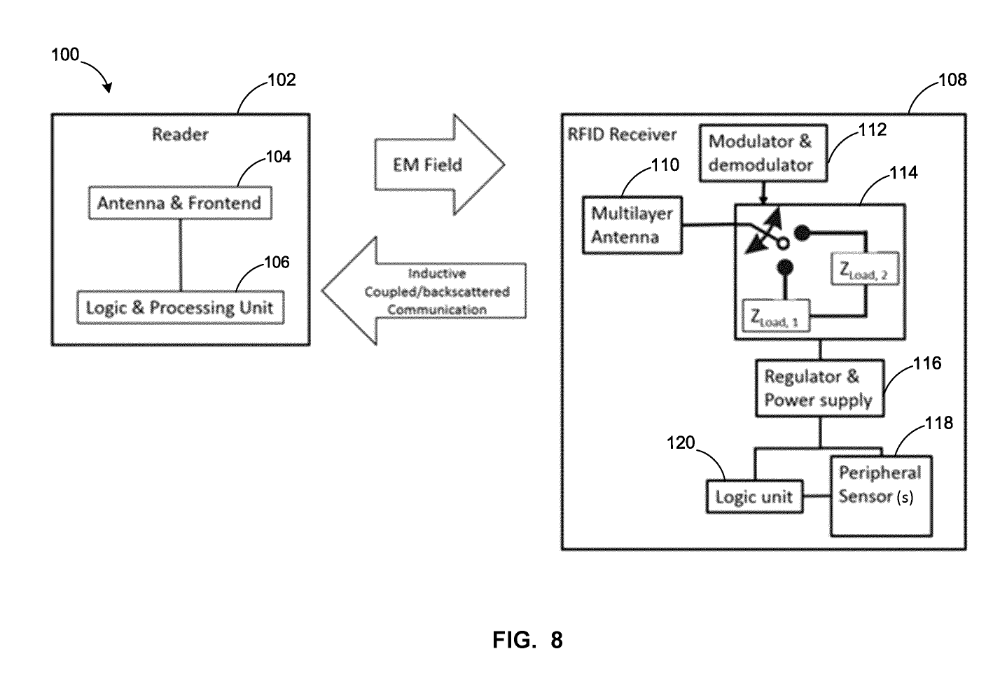

Referring now to FIG. 8, shown therein is a block diagram of an example embodiment of a communication system 100 that includes a wireless reader 102 and a multilayer micro-receiver 108 in accordance with the teachings herein. The communication system 100 is wirelessly powered and provides electromagnetic (EM) fields such that it is suitable to be worn by a user, for example. The wireless power may be facilitated by EM fields that are generated by the reader 102 and sent to the receiver 108 to induce currents thereat to provide power for the operation of associated microcircuitry including, but not limited to, a low power sensor, for example.

In at least some embodiments, the communication system 100 may also use a protocol, as is known by those of common skill in the art, which allows the reader 102 to be compatible with common EM devices. In this regard, the reader 102 may intentionally have a simple design to promote a universal usability across all devices that support various types of EM protocols, such as NFC.

The reader 102 comprises an NFC antenna and front-end stage 104 as well as a logic and processing unit 106. The reader 102 acts as a power source for several electronic components of the receiver 108. The reader 102 may be provided by devices including a mobile device such as a smartphone. The mobile device may be NFC-enabled or an NFC identification tag reader in which case the frequency may be at 13.56 MHz and an NFC antenna is used. In general, many types of EM fields may be used along with suitable compatible antennas. For example, 915 MHz uses GSM antennas, and 2.45 GHz uses wiki antennas.

Alternatively, the reader 102 may be designed to function with the receiver 108 and may be subtly made into a common accessory such as, but not limited to, a key-chain, glasses, a necklace, and the like.

The reader 102 picks up signals that are transmitted by the receiver 108 by using inductive coupling or backscattered communication. From a usability point of view, the difference between inductive coupling and backscattered communication is distance, frequency, and antenna size. Backscattered communication has a larger span of frequency (typically the usage is from about 900 MHz to about 5.8 GHz). This allows the antenna to be much more compact. Backscattered communication also allows communication with wavelengths in the meter range, which is several orders of magnitude higher than inductively coupled communication. However, Inductive coupling is less sensitive to the human body. Nevertheless, the operating principle is the same from a reader/receiver perspective (meaning that they may use the same processing algorithm but rely on different physical phenomena for actual signal transmission.

The received signals have data which may be post-processed by the reader 102 for further analysis. The received data and/or processed data may be stored and may be displayed on the reader 102 to provide timely information about sensed data. For example, for health applications where the receiver 108 is collecting information about a living thing, such as a patient, then the information may be used for disease management.

In order to provide power to the micro receiver 108, which may be on a contact lens in some applications, the reader 102 is preferably in close proximity to the receiver 108. Furthermore, the reader may be preferably located with respect to the receiver 108 such that the transmission pathway is clear of any interference including any biological bodies. As an example, the reader 102 (which may also be referred to as a relay device), may be located on eye glasses, a key-chain, a necklace, or a clip which may be attached to the clothing, collar or tie of an individual that is “wearing” the receiver 108. While the distance is effectively larger for the latter example, the relative position remains relatively constant in motion. Multiple solutions might be developed depending on the need of the individual such as using a mobile phone, a belt-clipped or a lanyard-clipped dangle or a home appliance.

The receiver 108 generally comprises a multilayer antenna 110, a radio having a modulator and demodulator 112, an impedance matching network 114, a power regulator 116, a logic unit 120 and at least one peripheral sensor 118. Since minimal radio-frequency (RF) absorption is desirable in the transmission of the power signal and the sensor signals, the operational frequency may be chosen to be optimal for non-invasive biomedical devices.

The multilayer antenna 110 may be implemented in accordance with the various teachings herein. The multilayer antenna 110 may be operated at a low frequency of about 13.98 MHz, for example, for minimal biological interference in applications where the receiver is disposed close to a biological surface.

The modulator and demodulator stage 112 includes circuitry that is needed for the reception and transmission of signals. This circuitry may include filters, amplifiers and feedback components. The multilayer antenna 110 is coupled to the modulator and demodulator stage by the impedance matching stage 114 which tries to match the impedance of two portions of the receiver that are coupled to one another so that any signals that are transmitted therebetween are not reflected as much thereby improving signal to noise ratio (SNR).

The regulator and power supply stage 116 provide a regulated stable voltage which may be used as a supply voltage by other components of the receiver 108 that typically operate in the micro-Watt energy level. For example, the regulator and power supply stage 116 may behave as an energy harvester which obtains energy from an energy storage device, such as a capacitor, and functions as a potentiostat circuit in order to provide the regulated voltage which is used as a power supply voltage. Accordingly, the regulator and power supply stage 116 comprises circuitry that may be used for the control, regulation and distribution of voltage.

The peripheral sensor(s) 118 may include biosensors that are implemented and operated for detecting certain bio-markers and/or for use in specific detection applications. The peripheral sensor(s) 118 generally function under regulated voltages that are provided by the regulator and power supply stage 116.

The logic unit 120 may act as a baseband processor in that it may process different signals from the peripheral sensor(s) 118. This processing may be done in parallel depending on the computing power of the logic unit 120 and the amount of data that may be processed. Once the signals are processed, they are transmitted to the modulator and demodulator stage 112 for further RF processing to be transmitted as wireless signals by the multilayer antenna 110.

In use energy that is transmitted from the reader 102 is drawn wirelessly through the multilayer antenna 110 and may be stored in an energy storage device such as an on-chip capacitor (not shown). This energy is then processed by the regulator and power supply stage 116 for usage by different components of the receiver 108 to perform various functions. For example, this energy may be stored and then used to power an RFIC (e.g. the modulator and demodulator stage 112) which conditions sensed signal data and prepares it for RF communication through the multilayer antenna 110. The RF signals that are transmitted by the receiver 108 may be picked up by the reader 102 for processing and display. In order to have a low power communication system, an analog RFIC is the preferred.

In alternative embodiments, a piezoelectric layer residing below the functional modules of the receiver 108 may be configured to harvest energy from the blinking motion of the user's eye when the receiver is mounted on a contact lens or an ocular wedge. This piezoelectric layer may comprise nanowires and nano-rods made of different piezoelectric materials to support, stabilize, and power various components of the receiver 108.

In yet other alternative embodiments, a thin film solar cell module may be incorporated within the hydrogel matrix to harvest energy from external light sources.

In yet other alternative embodiments, a micro-motive layer at the bottom of the contact lens on which the receiver is mounted may harvest energy from mechanical friction, bending and stretching of the contact lens.

There are several parameters for which values may be selected to result in an appropriate trade-off between these parameters. These parameters include the energy budget, the transmission distance, the data collection intervals, the operation frequency, and the physical size of the receiver 109. These factors help to finalize the eventual product design of both the receiver 109 and the reader 102.

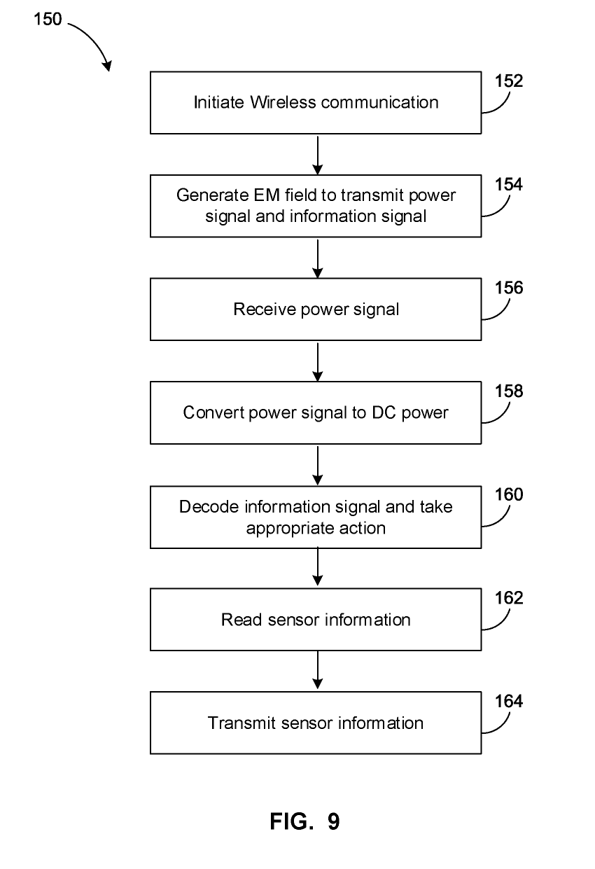

Referring now to FIG. 9, shown therein is a flowchart of an example embodiment of a method 150 of operation for the communication system 100 in accordance with the teachings herein. The method 150 includes sensing data obtained by the multilayer receiver 108 and monitoring the data at the reader 102.

At 152, the method 150 comprises initiating wireless communication at the reader 102 by preparing information and/or power that is to be transmitted to the receiver 108. At 154, the reader 102 generates a wireless signal with an EM field that carries both power and information and transmits the wireless signal to the receiver 108.

At 156, the method 150 the wireless signal received at the receiver 108 and the EM field of the wireless signal induces a signal at the multilayer antenna 110.

At 158, the method 150 generally comprises converting the power signal that was received at the receiver 108 into a stable, regulated DC power signal which may be used as a supply voltage for several components of the receiver 108. For example, the DC power signal may be used to power the logic unit 120 and the peripheral sensor(s) 118.

At 160, the method 150 may comprise processing any information by decoding it to determine if there are any instructions that were sent to the receiver 108 from the reader 102. This processing may be done by the demodulator 112 and the logic unit 120. The information signal is decoded by the demodulator and logic unit, which may be used to control the peripheral hardware. If it is determined that there were instructions in the signal sent by the reader 102, then the appropriate action is taken by the logic unit 120. For example, this information may be used to control the peripheral hardware including the peripheral sensor(s) 118.

At 162, the method 150 may comprise reading information that was obtained by the peripheral sensor(s) 118. The sensed information may be further processed by other devices in which case the sensed information may be transmitted to the reader 102.

At 164, the method 150 may comprise transmitting the sensed information to the reader 102 for storage and/or further processing. The sensed information may be sent by generating a weaker EM field using the multilayer antenna 108.

It should also be understood that at least some of the elements described herein that are at least partially implemented via software may be written in a high-level procedural language such as object oriented programming or a scripting language. Accordingly, the program code may be written in at least one of C, C⁺⁺, SQL or any other suitable programming language and may comprise modules or classes, as is known to those skilled in object oriented programming. It should also be understood that at least some of the elements of the microcircuitry that are implemented via software may be written in at least one of assembly language, machine language or firmware as needed. In either case, the program code can be stored on a storage media or on a computer readable medium that bears computer usable instructions for one or more processors and is readable by a general or special purpose programmable computing device having at least one processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

Furthermore, the computer readable medium may be provided in various non-transitory forms such as, but not limited to, one or more diskettes, compact disks, tapes, chips, USB keys, magnetic and electronic storage media and external hard drives or in various transitory forms such as, but not limited to, wire-line transmissions, satellite transmissions, internet transmissions or downloads, digital and analog signals, and the like. The computer useable instructions may also be in various forms, including compiled and non-compiled code.

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments described herein, the general scope of which is defined in the appended claims.

1. A micro-antenna comprising:
a first substrate layer having a first antenna winding trace thereon;
a second substrate layer having a second antenna winding trace thereon; and
at least two couplers to couple the first and second antenna winding traces.

2. The micro-antenna of claim 1, further comprising a passivation layer that covers the antenna winding trace on a topmost substrate layer.

3. The micro-antenna of claim 2, wherein at least one of the substrate layers and the passivation layer comprises water impermeable material.

4. The micro-antenna of claim 3, wherein the water impermeable material comprises at least one of polyimide, polyurethane, and parylene.

5. The micro-antenna of claim 1, wherein the antenna winding traces from different substrate layers at least partially overlap with one another.

6. The micro-antenna of claim 1, wherein the antenna winding trace on a given substrate layer is at least partially concentric.

7. The micro-antenna of claim 1, wherein the antenna winding trace on a given substrate layer comprises at least two loops that do not intersect.

8. The micro-antenna of claim 1, further comprising micro-vias for coupling the antenna winding traces on different substrate layers.

9. The micro-antenna of claim 1, wherein the antenna winding traces generally have a circular shape.

10. The micro-antenna of claim 1, wherein the substrate layers have a circular shape and the winding traces are disposed along an outer ring of the substrate layers.

11. The micro-antenna of claim 1, wherein the antenna winding traces comprise metal having at least one of copper, gold, silver and conductive ink.

12. The micro-antenna of claim 1, wherein the substrate layers of the micro-antenna are shaped to be received on a contact lens and the substrate layers are made from a biocompatible polymer.

13. The micro-antenna of claim 12, wherein the biocompatible polymer comprises one or more biocompatible polymeric materials including polyimide, hydrogel, polyethylene terephthalate (PET), polyurethane, parylene, polyethylene naphthalate, polypropylene, polyimide, polyimide, and thermoplastics.

14. The micro-antenna of claim 1, wherein the antenna winding traces have one of a square, rectangular, triangular, star and elliptical shape or a meander in shape.

15. The micro-antenna of claim 1, further comprising at least one additional substrate layer having antenna winding traces thereon that are coupled to at least one of the antenna winding traces on the first and second substrate layers.

16. A receiver for a communication system, wherein the receiver comprises:
a multilayer antenna comprising:
a first substrate layer having a first antenna winding trace thereon;
a second substrate layer having a second antenna winding trace thereon; and
at least two couplers to couple the first and second antenna winding traces; and
microcircuitry disposed on at least one of the substrate layers and coupled to a first and second portion of the multilayer antenna.

17. The receiver of claim 16, wherein the receiver further comprises a passivation layer covering the microcircuitry on a topmost substrate layer.

18. The receiver of claim 16, wherein the substrate layers have a circular shape, the winding traces are disposed along an outer ring of the substrate layers and the microcircuitry is disposed along a portion of the outer ring.

19. The receiver of claim 16, wherein the microcircuitry comprises one or more of at least one IC, at least one sensor and at least one chip-less system.

20. The receiver of claim 16, wherein the microcircuitry comprises at least one IC and at least one sensor, an energy storage device, at least one biosensor for detecting certain bio-markers, a micro-motive layer and an element configured to harvest energy.
